(19) United States
(12) Patent Application Publication
(10) Pub. No.: US 2017/0254411 A1
(43) Pub. Date: Sep. 7, 2017

(54) AUTOMATIC TRANSMISSION FOR VEHICLE

(71) Applicant: AISIN SEIKI KABUSHIKI KAISHA, Kariya-shi (JP)

(72) Inventor: Koji HARADA, Aichi-ken (JP)

(73) Assignee: AISIN SEIKI KABUSHIKI KAISHA, Kariya-shi (JP)

(21) Appl. No.: 15/446,305

(22) Filed: Mar. 1, 2017

(30) Foreign Application Priority Data
Mar. 1, 2016 (JP) 2016-039117

(51) Int. Cl. F16H 61/00; F16H 59/66; F16H 59/52

(52) U.S. Cl. CPC F16H 61/0021; F16H 59/52; F16H 59/66; F16H 2059/147

(57) ABSTRACT

An automatic transmission for a vehicle includes: an automatic transmission mechanism including friction engaging elements which change a power transmission path between an input shaft and an output shaft, an engaging oil pressure control unit which controls an engaging oil pressure that engages a first friction engaging element, and a releasing oil pressure control unit which controls a releasing oil pressure that releases a second friction engaging element, so as to achieve upshifting to a predetermined gear shift stage; and a control device including an engaging oil pressure computing unit which calculates and outputs the engaging oil pressure, a releasing oil pressure computing unit which calculates and outputs the releasing oil pressure, a pulled state determination unit which determines whether or not the vehicle is in a pulled state, and a travel load increase calculation unit which calculates an increase in travel load of the vehicle.

### CROSS REFERENCE TO RELATED APPLICATIONS

This application is based on and claims priority under 35 U.S.C. §119 to Japanese Patent Application 2016-039117, filed on Mar. 1, 2016, the entire contents of which are incorporated herein by reference.

### TECHNICAL FIELD

This disclosure relates to an automatic transmission for a vehicle which is mounted on a vehicle, and particularly to a hydraulic control during upshifting in so-called clutch-to-clutch (grip changing) transmission which shifts gear to a predetermined gear shift stage by engaging one friction engaging element and by releasing the other friction engaging element.

### BACKGROUND DISCUSSION

An engaging oil pressure which engages the one friction engaging element and a releasing oil pressure which releases the other friction engaging element in the related art are controlled based on an input torque that acts on an input shaft of an automatic transmission which inputs power from an engine output shaft (for example, refer to Japanese Patent No. 3334485).

However, in such a configuration, during the upshifting, in a case where a state where a second torque which is a torque in the same direction is applied to the automatic transmission in addition to a first torque which is an input torque from the engine output shaft is generated, a state where the engaging oil pressure and the releasing oil pressure are insufficient is generated, and blow-up of an engine is generated or a defect that damages durability of a friction material of the friction engaging element is generated.

In addition, during the upshifting, as an example in which a state where the second torque is applied to the automatic transmission in addition to the first torque is generated, in a case where a vehicle is in a pulled state, for example, as illustrated in FIG. 1, during the upshifting in the middle of travelling as a tractor 1 pulls a trailer 3 via a connector 5 which links a coupler 2 provided in the tractor 1 on a front side of the vehicle and a king pin 4 provided in the trailer 3 on a rear side of the vehicle, a case of deceleration by returning an accelerator pedal (not illustrated) is generated. According to the deceleration, the trailer 3 which is being pulled fills a clearance 6 between the coupler 2 and the king pin 4 in the connector 5, and as illustrated by a white arrow of FIG. 1, the second torque is applied to the automatic transmission to push out the tractor 1 forward.

Thus, a need exists for an automatic transmission for a vehicle which is not susceptible to the drawback mentioned above.

### SUMMARY

An automatic transmission for a vehicle according to an aspect of this disclosure includes: an automatic transmission mechanism that includes a plurality of friction engaging elements which change a power transmission path between an input shaft to which power is input from an engine output shaft of a vehicle and an output shaft linked to a driving wheel of the vehicle, an engaging oil pressure control unit which controls an engaging oil pressure that engages a first friction engaging element among the plurality of friction engaging elements, and a releasing oil pressure control unit which controls a releasing oil pressure that releases a second friction engaging element, so as to achieve upshifting to a predetermined gear shift stage; and a control device that includes an engaging oil pressure computing unit which calculates the engaging oil pressure based on a first torque which is an input torque input to the input shaft, and outputs the engaging oil pressure to the engaging oil pressure control unit, a releasing oil pressure computing unit which calculates the releasing oil pressure based on a holding torque of the first friction engaging element calculated from the engaging oil pressure and the first torque, and outputs the releasing oil pressure to the releasing oil pressure control unit, a pulled state determination unit which determines whether or not the vehicle is in a pulled state, and a travel load increase calculation unit which calculates an increase in travel load of the vehicle, in which the control device increases at least one of the engaging oil pressure and the releasing oil pressure immediately before rotation variance of the input shaft is generated based on an increase in travel load of the vehicle calculated by the travel load increase calculation unit in a case where it is determined that the vehicle is in a pulled state by the pulled state determination unit.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view of a linking vehicle;

FIG. 2 is a block diagram illustrating an automatic transmission for a vehicle disclosed here;

FIG. 3 is a view illustrating an example of a calculation map which calculates a base value of a target engaging oil pressure;

FIG. 4 is a view illustrating an example of a correction map which calculates a correction value of the target engaging oil pressure based on an increase in a vehicle mass;

FIG. 5 is a view illustrating an example of a correction map which calculates a correction value of the target engaging oil pressure based on a gradient degree of a downward slope;

FIG. 6 is a main flowchart of a control program of an upshift control executed by a control device illustrated in FIG. 2;

FIG. 7 is a flowchart illustrating a first embodiment of an engaging clutch control and a releasing clutch control;

FIG. 8 is a flowchart illustrating a torque phase transmission control of the engaging clutch control illustrated in FIG. 7;

FIG. 9 is a timing chart illustrating the first embodiment of the engaging clutch control and the releasing clutch control;

FIG. 10 is a timing chart illustrating a second embodiment of the engaging clutch control and the releasing clutch control; and

FIG. 11 is a timing chart illustrating a third embodiment of the engaging clutch control and the releasing clutch control.

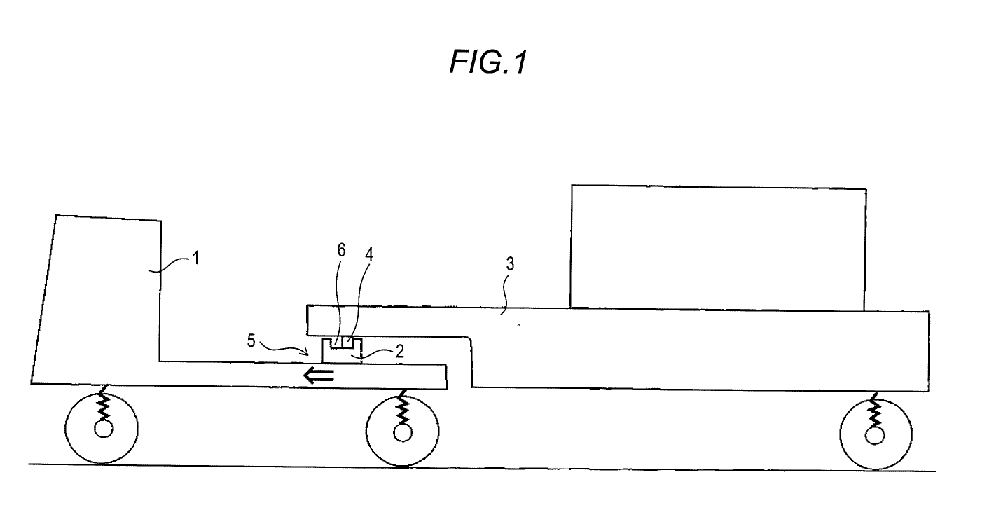

### DETAILED DESCRIPTION

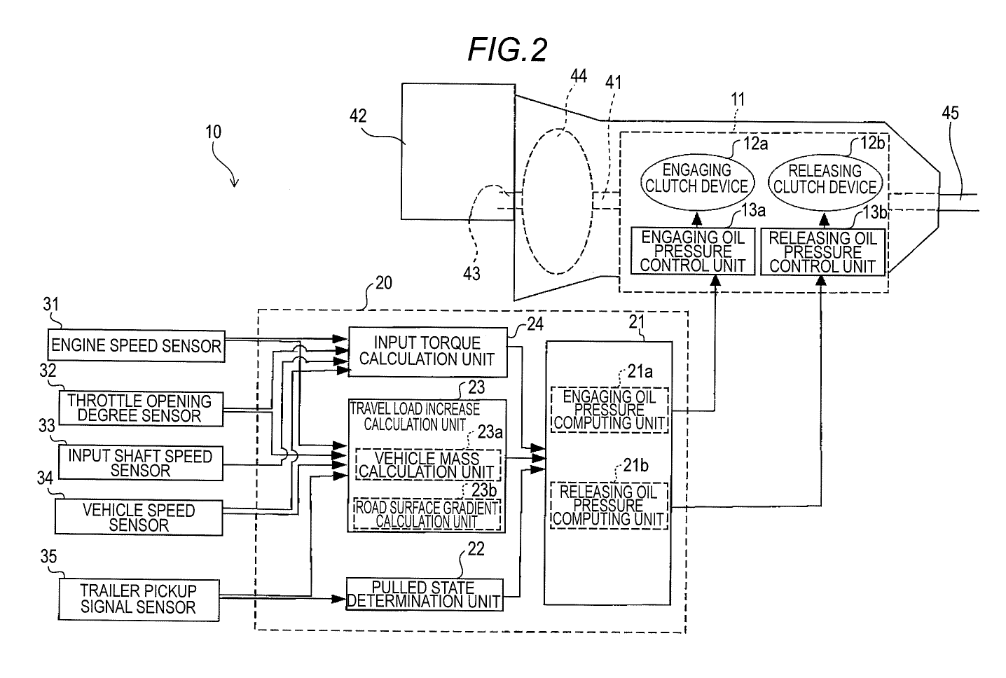

FIG. 2 schematically illustrates an automatic transmission for a vehicle 10, and as is known, the automatic transmission for a vehicle 10 includes an automatic transmission mechanism 11 which includes friction engaging elements, such as multiple clutch devices or a brake device, and performs automatic transmission by selecting a power transmission path of a planetary gear unit (not illustrated) by appropriately disconnecting and connecting the friction engaging elements. An input shaft 41 of the automatic transmission mechanism 11 is linked to an engine output shaft 43 of an engine 42 via a torque converter 44, and an output shaft 45 is linked to a driving wheel (not illustrated).

The automatic transmission mechanism 11 switches the power transmission path of the planetary gear unit by disconnecting and connecting the plurality of friction engaging elements (the clutch device and the brake device), and achieves a gear shift stage, such as a forward 5-th stage and a backward 1-st stage. An upshift control by grip changing (clutch-to-clutch) of the friction engaging element will be described, for example, based on 2-3 transmission. In addition, in the automatic transmission mechanism 11, the 2-3 transmission is achieved by engaging an engaging clutch device 12a which is a first friction engaging element and by releasing a releasing clutch device 12b which is a second friction engaging element together.

According to this, an engaging oil pressure control unit 13a which generates an engaging oil pressure Pe that engages the engaging clutch device 12a, and supplies the engaging oil pressure Pe to the engaging clutch device 12a, is provided. Similarly, a releasing oil pressure control unit 13b which generates a releasing oil pressure Pr that releases the releasing clutch device 12b, and supplies the releasing oil pressure Pr to the releasing clutch device 12b, is provided.

Each signal from an engine speed sensor 31, a throttle opening degree sensor 32, an input shaft speed (=turbine speed) sensor 33 and a vehicle speed (=output shaft speed of the automatic transmission mechanism 11) sensor 34 of the automatic transmission mechanism 11, and a trailer pickup signal sensor 35, is input to a control device 20 configured of a microcomputer. The control device 20 performs computation of the engaging oil pressure Pe and the releasing oil pressure Pr by an oil pressure computing unit 21, and outputs the computation result to the engaging oil pressure control unit 13a and the releasing oil pressure control unit 13b.

The oil pressure computing unit 21 includes: an engaging oil pressure computing unit 21a which computes the engaging oil pressure Pe generated by the engaging oil pressure control unit 13a and outputs the computation result to the engaging oil pressure control unit 13a; and a releasing oil pressure computing unit 21b which computes the releasing oil pressure Pr generated by the releasing oil pressure control unit 13b and outputs the computation result to the releasing oil pressure control unit 13b.

In the computation of the engaging oil pressure Pe, the engaging oil pressure computing unit 21a calculates a base value Pea( )(target value at a normal time) of a target engaging oil pressure Pea output to the engaging clutch device 12a based on a first torque Qi which is an input torque input to the input shaft 41, as a target oil pressure immediately before the rotation variance of the input shaft 41 is generated. The base value Pea0 of the calculated target engaging oil pressure Pea is output to the engaging oil pressure control unit 13a from the engaging oil pressure computing unit 21a. In addition, the calculation of the first torque Qi which is an input torque is performed by an input torque calculation unit 24 of the control device 20, and will be described later.

As illustrated in FIG. 2, each signal from the engine speed sensor 31, the throttle opening degree sensor 32, the input shaft speed sensor 33, and the vehicle speed sensor 34, is input to the input torque calculation unit 24. First, the input torque calculation unit 24 acquires a throttle opening degree θ by the throttle opening degree sensor 32 and an engine torque Qe based on an engine speed Ne by the engine speed sensor 31 by using a map. Then, the input torque calculation unit 24 counts a velocity ratio from the input and output speed of the torque converter 44 by the input shaft speed sensor 33 and the engine speed sensor 31, acquires a torque ratio by the velocity ratio, multiplying the torque ratio by the engine torque Qe, and calculates the first torque Qi.

In the computation of the releasing oil pressure Pr, the releasing oil pressure computing unit 21b calculates a base value Prb0 of a target releasing oil pressure Prb output to the releasing clutch device 12b based on a holding torque Qa and the first torque Qi of the engaging clutch device 12a which are calculated from the base value Pea0 of the target engaging oil pressure Pea as a target oil pressure immediately before the rotation variance of the input shaft 41 is generated. The base value Prb0 of the calculated target releasing oil pressure Prb is output to the releasing oil pressure control unit 13b from the releasing oil pressure computing unit 21b.

The base value Pea0 of the target engaging oil pressure Pea and the base value Prb0 of the target releasing oil pressure Prb can be acquired based on the following Equation 1, Equation 2, and Equation 3, for example, in a case where a generally known multiplate type clutch, such as the engaging clutch device 12a and the releasing clutch device 12b, is used. In addition, Qa (Nm) indicates a holding torque (transmission torque) by the engaging clutch device 12a immediately before the rotation variance of the input shaft 41 is generated, and Qb (Nm) indicates a holding torque (transmission torque) by the releasing clutch device 12b immediately before the rotation variance of the input shaft 41 is generated. n indicates the number of friction surfaces, μ is a coefficient of friction, Dpo indicates a piston large diameter (m), Dpi indicates a piston small diameter (m), Fr indicates a piston return spring set load (N), Do indicates a large diameter (m) of the friction surface, and Di indicates a small diameter (m) of the friction surface.

$$\begin{matrix}Qa + Qb = Qi & Equation 1 \\ Qa = \frac{N μ}{4} ( π Pea \frac{{Dpo}^{2} - {Dpi}^{2}}{4} - Fr ) ( Do + Di ) & Equation 2 \\ Qb = \frac{N μ}{4} ( π Prb \frac{{Dpo}^{2} - {Dpi}^{2}}{4} - Fr ) ( Do + Di ) & Equation 3\end{matrix}$$

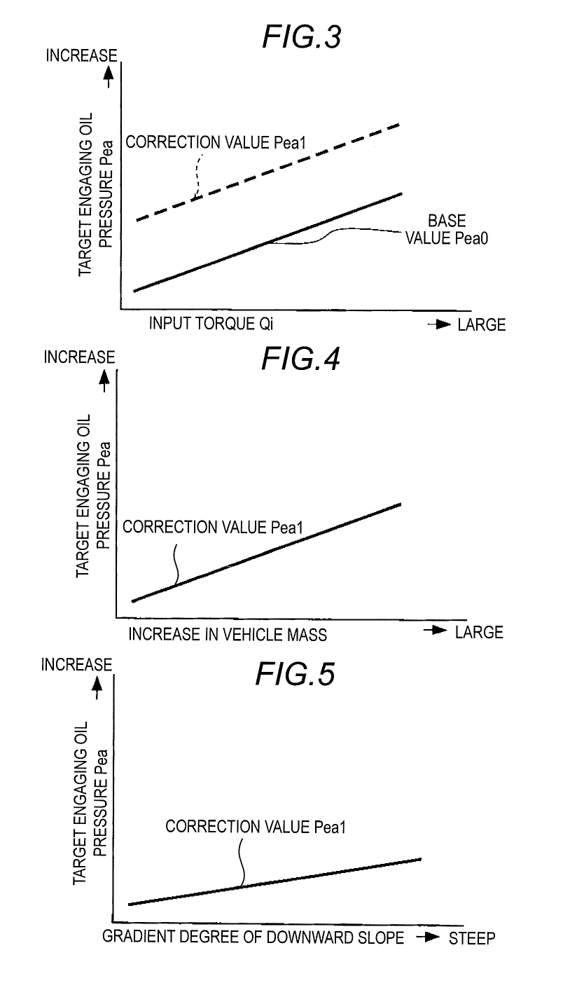

In addition, as illustrated by a solid line of a calculation map of FIG. 3, the calculation of the base value Pea0 of the target engaging oil pressure Pea can be calculated by using a value stored in a form of a map in advance. Similarly, it is apparent that the calculation of the base value Prb0 of the target releasing oil pressure Prb can be calculated by using the map.

The control device 20 includes: a pulled state determination unit 22 which determines whether or not the vehicle is in a pulled state; and a travel load increase calculation unit 23 which calculates an increase in travel load of the vehicle. The control device 20 increases at least one of the base value Pea0 of the target engaging oil pressure Pea and the base value Prb0 of the target releasing oil pressure Prb based on the increase in travel load calculated by the travel load increase calculation unit 23 in a case where it is determined that the vehicle is in a pulled state by the pulled state determination unit 22.

Specifically, in a case where the signal which illustrates a pulled state is input to the control device 20 from the trailer pickup signal sensor 35, the pulled state determination unit 22 determines that the pulled state determination unit 22 is in a state where the first torque Qi which is an input torque input to the input shaft 41 and a second torque Qs which is a torque in the same direction are generated. Therefore, in a case where the pulled state determination unit 22 determines that the vehicle is in a pulled state, the oil pressure computing unit 21 increases at least one of the base value Pea0 of the target engaging oil pressure Pea and the base value Prb0 of the target releasing oil pressure Prb to correction values Pea1 and Prb1 based on the increase in travel load calculated by the travel load increase calculation unit 23. In addition, the trailer pickup signal sensor 35 can detect the signal which indicates that the vehicle is in a pulled state, for example, from a trailer brake (not illustrated) or a pulling mode switch (not illustrated).

As illustrated in FIG. 2, each signal from the engine speed sensor 31, the throttle opening degree sensor 32, the vehicle speed sensor 34, and the trailer pickup signal sensor 35 is input to the travel load increase calculation unit 23. Specifically, as illustrated in FIG. 2, the travel load increase calculation unit 23 includes a vehicle mass calculation unit 23a which calculates a mass of the vehicle, and a road surface gradient calculation unit 23b which calculates a road surface gradient which is a gradient of a road surface on which the vehicle travels.

The vehicle mass calculation unit 23a can calculate the vehicle mass according to the presence or the absence of the trailer pickup signal indicating that the trailer is linked, by using the trailer pickup signal sensor 35. For example, in a case where the trailer pickup signal sensor 35 outputs a trailer pickup signal ON, it is possible to set the vehicle mass to be 50 t or to be 10 t when the trailer pickup signal is OFF, and to calculate an increase in vehicle mass which is an increase in travel load.

As is generally known, practical acceleration and reference acceleration of the vehicle are counted such that the road surface gradient calculation unit 23b calculates a gradient of a road surface on which the vehicle travels. The former practical acceleration can be counted as a change amount per unit time of a vehicle speed detected by the vehicle speed sensor 34. In addition, the latter reference acceleration is acceleration obtained when travelling on a flat road surface, and is stored in a form of a map in advance as a value that corresponds to the throttle opening degree detected by the throttle opening degree sensor 32 and the vehicle speed detected by the vehicle speed sensor 34. Therefore, the value which corresponds to the detected throttle opening degree and the vehicle speed is acquired as the reference acceleration from the map.

When the road surface gradient is counted from the practical acceleration and the reference acceleration which are obtained in this manner, that is, when the travel road surface is inclined, the acceleration or the deceleration acts on the vehicle in accordance with the gradient. Therefore, a difference between the reference acceleration and the practical acceleration which are acquired based on the throttle opening degree and the vehicle speed is generated, and the difference of the accelerations becomes a value which corresponds to the gradient of the road surface. Here, the road surface gradient calculation unit 23b acquires a relationship between the acceleration and the road surface gradient in advance, and can compute the road surface gradient in which the travel load increases based on the counted difference of the accelerations.

In a case where the pulled state determination unit 22 determines that the vehicle is in a pulled state, the oil pressure computing unit 21 performs correction in which at least one of the base value Pea0 of the target engaging oil pressure Pea and the base value Prb0 of the target releasing oil pressure Prb is increased to the correction value Pea1 and the correction value Prb1 based on the increase in travel load calculated by the travel load increase calculation unit 23. In addition, in the calculation map of FIG. 3, an example in which the base value Pea0 of the target engaging oil pressure Pea is increased to the correction value Pea1 is illustrated by a broken line. The size of increase in travel load calculated by the travel load increase calculation unit 23 influences the size of the second torque Qs.

In other words, within an increase in travel load, in the vehicle mass, the vehicle mass increases from 10 t of a vehicle mass in a non-pulled state at a normal time to 50 t of a vehicle mass in a pulled state, and in the road surface gradient, based on a gradient degree to the downward slope from the flat road at a normal time, correction of increasing at least one of the base value Pea0 of the target engaging oil pressure Pea and the base value Prb0 of the target releasing oil pressure Prb to the correction value Pea1 and correction value Prb1 by the oil pressure computing unit 21 is performed. In addition, the calculation of the vehicle mass can also be performed by determining that the vehicle mass is small when the acceleration is high at a predetermined driving force, and by determining that the vehicle mass is large when the acceleration is small, based on the relationship between the acceleration of the vehicle and a driving force. As is generally known, the calculation of the driving force can be performed by multiplying the deceleration ratio by the above-described engine torque Qe, and by dividing the deceleration ratio by a radius of the driving wheel. In addition, regarding the second torque Qs, since the second torque Qs is unlikely to be generated in an uphill road in which a rising gradient is greater than a predetermined value, in a case of the uphill road in which the calculated rising gradient is greater than the predetermined value, the oil pressure computing unit 21 stops the correction of increasing the base value Pea0 of the above-described target engaging oil pressure Pea and the base value Prb0 of the target releasing oil pressure Prb.

The increase to the correction value Pea1 of the target engaging oil pressure Pea and the correction value Prb1 of the target releasing oil pressure Prb can be performed by using a correction map. In addition, an example of a correction map which calculates the correction value Pea1 of the target engaging oil pressure Pea based on the increase in vehicle mass is illustrated in FIG. 4. In addition, in FIG. 5, an example of a correction map which calculates the correction value Pea1 of the target engaging oil pressure Pea based on the gradient degree of the downward slope is illustrated. In addition, the correction of the increase in oil pressure in the oil pressure computing unit 21 is similarly performed based on the increase in travel load, but both of the increase in vehicle mass and the gradient degree of the downward slope of a road surface on which the vehicle travels are not necessary as an increase in travel load, and it is apparent that the oil pressure correction may be performed based on the increase in vehicle mass only in a case where the vehicle mass increases due to the change to a pulled state.

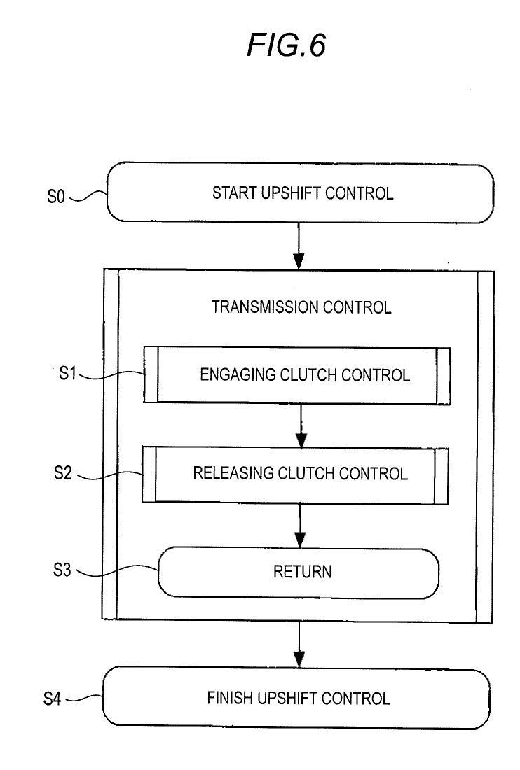

In the upshift control based on the above-described 2-3 transmission, as illustrated in FIG. 6, a transmission control is performed by circulating (S3) an engaging clutch control (S1) and a releasing clutch control (S2) in accordance with an upshift control start (S0) by the control device 20, and then, the upshift control is finished (S4).

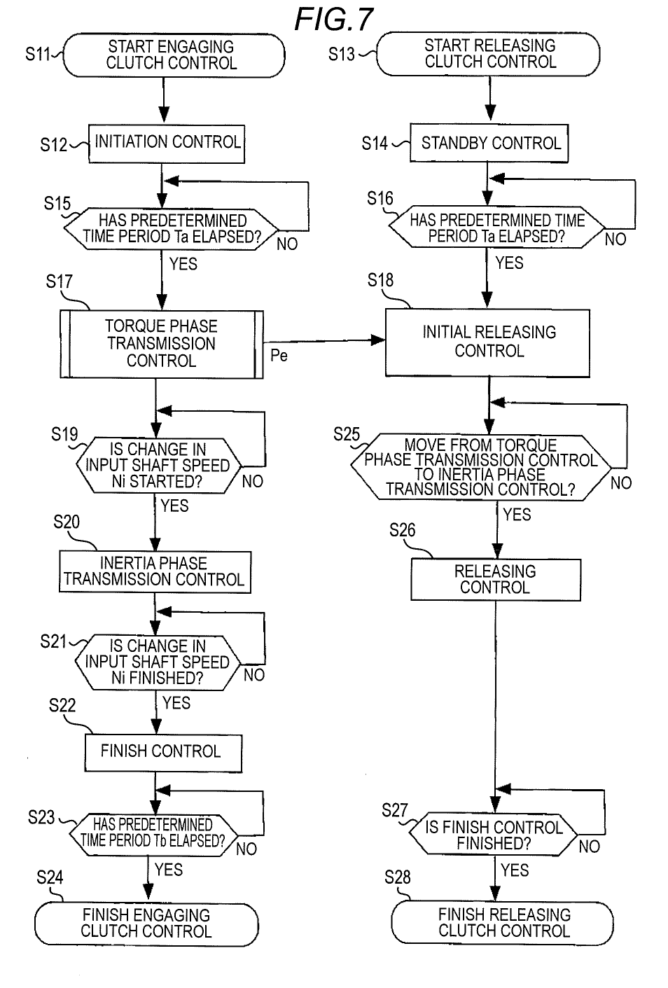

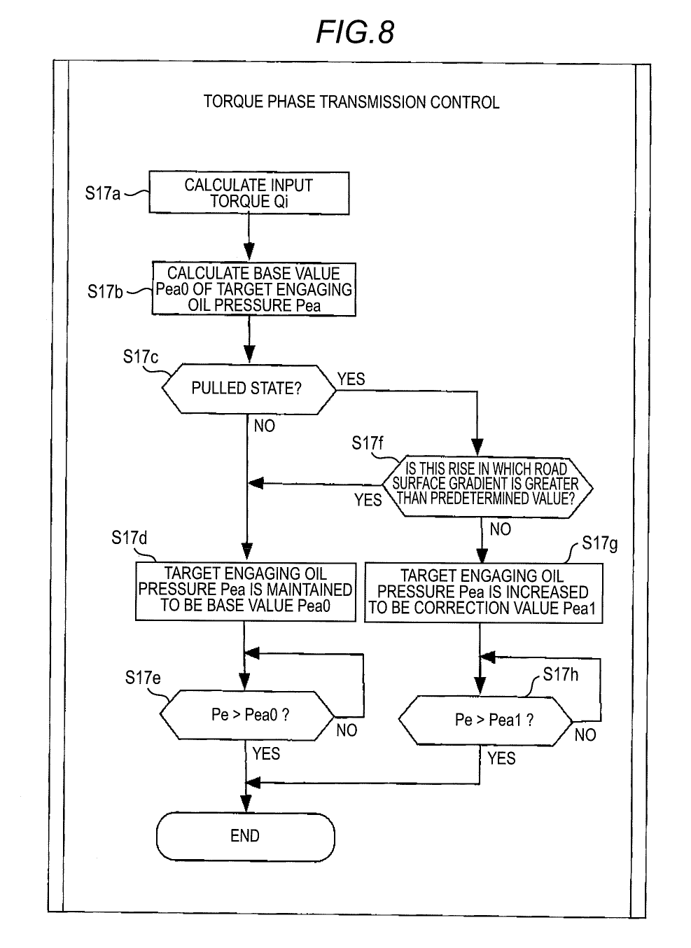

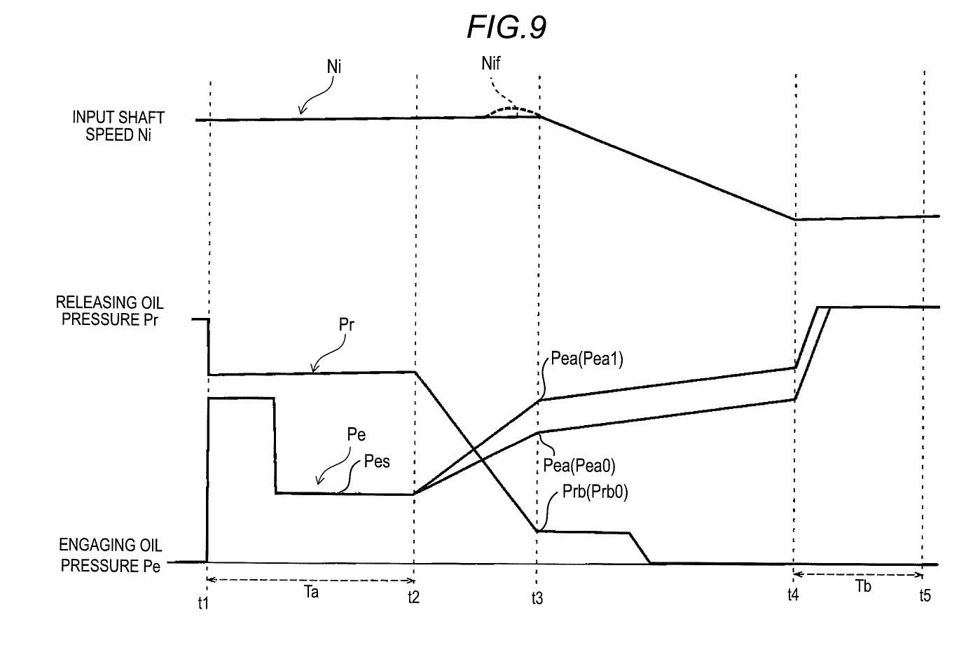

Next, along the timing charts of FIGS. 7 and 8 and the timing chart of FIG. 9, a first embodiment of the engaging clutch control (S1) and a releasing clutch control (S2) which are executed by the control device 20 will be described. An initiation control of the engaging clutch device 12a is performed in accordance with an engaging clutch control start (S11), that is, 2-3 transmission determination (t1 of FIG. 9) by the control device 20 (S12).

Similarly, a standby control of the releasing clutch device 12b is performed in accordance with the releasing clutch control start (S13) by the 2-3 transmission determination (t1) by the control device 20 (S14). The standby control continues for a predetermined time period Ta which will be described later (“YES” in S16).

In addition, in the initiation control (S12, t1 to t2 of FIG. 9), the engaging oil pressure Pe to the engaging clutch device 12a which is an oil pressure sufficient for starting the piston stroke is supplied first. In addition, the engaging oil pressure Pe is controlled to be a predetermined oil pressure Pes (piston stroke pressure) that fills a void of a friction plate as the stroke of a piston is performed. The predetermined time period Ta (t1 to t2 of FIG. 9) which is sufficient for similarly performing initiation of the engaging clutch device 12a is set in advance. The engaging clutch device 12a moves to a torque phase transmission control from an initiation control (S17, t2 of FIG. 9) after the predetermined time period Ta has elapsed (“YES” in S15) by the control device 20.

Meanwhile, in the standby control (S14, t1 to t2 of FIG. 9), the releasing oil pressure Pr is maintained to be a predetermined pressure, and the releasing clutch device 12b is in a standby state until the initiation control is finished (S12, t1 to t2 of FIG. 9) while maintaining an engaged state where an engaged state of a 2-nd gear stage is held.

Next, the torque phase transmission control is performed by the engaging clutch device 12a by the control device 20 (S17, t2 to t3 of FIG. 9), and an initial releasing control is performed in the releasing clutch device 12b (S18, t2 to t3 of FIG. 9).

In the torque phase transmission control (S17, t2 to t3), as illustrated in FIG. 8, the control device 20 calculates the input torque Qi by the input torque calculation unit 24 (S17a). Next, the control device 20 calculates the base value Pea0 of the target engaging oil pressure by the engaging oil pressure computing unit 21a based on the calculated input torque Qi.

Next, the control device 20 determines whether or not the vehicle is in a pulled state by the pulled state determination unit 22 (S17c). In a case where it is determined that the vehicle is not in a pulled state (“NO” in S17c), the control device 20 (engaging oil pressure computing unit 21a) maintains the target engaging oil pressure Pea to be the base value Pea0 (S17d), and moves to step S17e.

In a case where it is determined that the vehicle is in a pulled state (“YES” in S17c), the control device 20 (engaging oil pressure computing unit 21a) moves to step S17f.

In step S17f, the control device 20 (engaging oil pressure computing unit 21a) determines whether or not the rise is a rise in which the road surface gradient on which the vehicle travels is greater than a predetermined value. In a case where it is determined that the rise is not the rise in which the road surface gradient on which the vehicle travels is greater than a predetermined value (“NO” in S17f), the target engaging oil pressure Pea is changed to the correction value Pea1 further increased than the base value Pea0 based on an increase in travel load by the control device 20 (travel load increase calculation unit 23) from the base value Pea0 (S17g), and moves to step S17h.

In a case where it is determined that the rise is a rise in which the road surface gradient on which the vehicle travels is greater than a predetermined value, (“YES” in S17f), the process moves to step S17d. In this manner, in a case where it is determined that the rise is a rise in which the road surface gradient on which the vehicle travels is greater than a predetermined value (“YES” in S17f), the increase in oil pressure is stopped based on the increase in travel load calculated by the travel load increase calculation unit 23, and the target engaging oil pressure Pea is maintained to be the base value Pea0.

In step S17e, the engaging oil pressure Pe of the engaging clutch device 12a is raised toward the base value Pea0 of the holding pressure (target engaging oil pressure) Pea computed based on the input torque Qi from the piston stroke pressure Pes, and the engaging oil pressure Pe of the engaging clutch device 12a continues until exceeding the base value Pea0 of the target engaging oil pressure Pea (“YES” in S17e).

In step S17h, the engaging oil pressure Pe of the engaging clutch device 12a is raised toward the correction value Pea1 of the holding pressure (target engaging oil pressure) Pea computed based on the input torque Qi from the piston stroke pressure Pes, and the engaging oil pressure Pe of the engaging clutch device 12a continues until exceeding the correction value Pea1 of the target engaging oil pressure Pea (“YES” in S17h).

In this manner, in the torque phase transmission control, the engaging oil pressure Pe of the engaging clutch device 12a is raised toward the holding pressure (target engaging oil pressure) Pea computed based on the input torque Qi from the piston stroke pressure Pes. The engaging clutch device 12a is placed in a sliding state while gradually increasing a torque capacity.

As described above, in a case where it is determined that the vehicle is in a pulled state, the control device 20 (engaging oil pressure computing unit 21a) raises the target engaging oil pressure Pea to the correction value Pea1 from the base value Pea0 based on the increase in vehicle load. As a result, it is possible to suppress an increase in speed Ni (broken line portion Nif in Ni of FIG. 9) of the input shaft 41 during the upshifting. Accordingly, it is apparent that blow-up of the engine speed Ne can be suppressed in the engine 42 linked to the input shaft 41.

Meanwhile, in the initial releasing control (S18, t2 to t3) of the releasing clutch device 12b, the base value Prb0 of the target releasing oil pressure Prb to the releasing clutch device 12b is calculated as a target oil pressure immediately before the rotation variance of the input shaft 41 is generated, by the control device 20 (releasing oil pressure computing unit 21b). Regarding the base value Prb0 of the target releasing oil pressure Prb, the holding torque Qb of the releasing clutch device 12b is counted based on the holding torque Qa and the input torque Qi of the engaging clutch device 12a which are calculated from the base value Pea0 of the target engaging oil pressure Pea, and the base value Prb0 is calculated based on the holding torque Qb.

The releasing oil pressure Pr of the releasing clutch device 12b decreases toward the base value Prb0 of the target releasing oil pressure Prb from a predetermined pressure that can hold an engaged state of the above-described 2-nd gear stage. Accordingly, in the initial releasing control, in the releasing clutch device 12b, the torque capacity gradually decreases and the input torque Qi moves to the engaging clutch device 12a.

Next, the control device 20 moves to an inertia phase transmission control from the torque phase transmission control (S20, t3 of FIG. 9) when a change in decrease in the input shaft speed Ni is detected by the input shaft speed sensor 33 (“YES” in S19, t3 of FIG. 9). The inertia phase transmission control is performed as the engaging oil pressure Pe gradually increases by a feedback control while detecting the change in decrease in input shaft speed Ni from the oil pressure in which the holding torque Qa of the engaging clutch device 12a is greater than the input torque Qi, and is continuously performed until reaching the entire rotation variance amount of the input shaft 41.

Next, the control device 20 moves to a finish control (S22, t4 of FIG. 9) when it is detected that there is not a change in input shaft speed Ni by the input shaft speed sensor 33 (“YES” in S21). In the finish control, at the time when the engaging oil pressure Pe increases until reaching a line pressure by a sudden gradient and a predetermined time period Tb has elapsed (S26, t5 of FIG. 9), the control of the engaging clutch device 12a is finished by the control device 20 (S24).

Meanwhile, in a case where the above-described engaging clutch device 12a is in a torque phase transmission control (t2 to t3 of FIG. 9), when the initial releasing control (t2 to t3 of FIG. 9) continues, the torque phase transmission control is finished, and the inertia phase transmission control is achieved (“YES” at S19, t3 of FIG. 9), the releasing clutch device 12b moves to the releasing control by the control device 20 (S26, t3 of FIG. 9).

In the releasing control, the releasing oil pressure Pr is rapidly released from the base value Prb0 of the target releasing oil pressure Prb, and is placed in a drain state. Next, when the finish control in the engaging clutch device 12a is finished (“YES” in S23, t5 of FIG. 9), the releasing control finishes the releasing clutch control (S28).

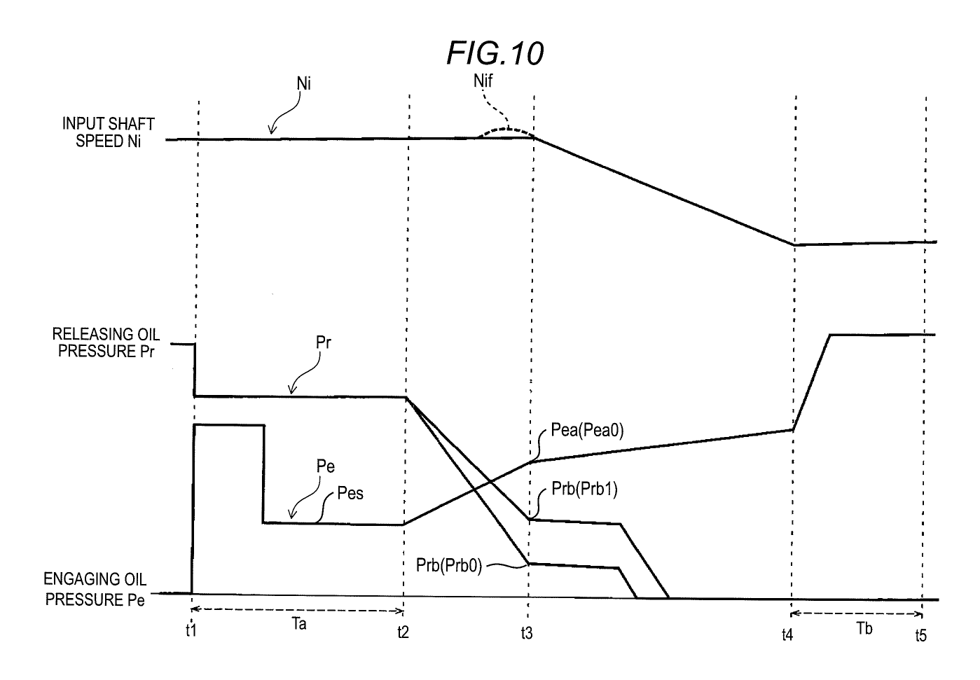

Next, as a second embodiment of the engaging clutch control and the releasing clutch control, another example of correction of increasing at least one of the base value Pea0 of the target engaging oil pressure Pea and the base value Prb0 of the target releasing oil pressure Prb will be described using FIG. 10. In the first embodiment illustrated in FIGS. 8 and 9, the oil pressure computing unit 21 corrects the base value Pea0 of the target engaging oil pressure Pea to be increased to the correction value Pea1 based on the increase in the above-described travel load. Instead of this, in the second embodiment, as illustrated in FIG. 10, the oil pressure computing unit 21 does not correct the base value Pea0 of the above-described target engaging oil pressure Pea based on the increase in the above-described travel load, and corrects the above-described target releasing oil pressure Prb to be increased to the correction value Prb1 from the base value Prb0. In this manner, even when the base value Prb0 of the target releasing oil pressure Prb is corrected to be increased to the correction value Prb1 based on the increase in travel load, similar to the first embodiment, it is possible to suppress' an increase in speed Ni (broken line portion Nif in Ni of FIG. 10) of the input shaft 41 during the upshifting. Accordingly, it is apparent that it is possible to suppress blow-up of the engine speed Ne in the engine 42 linked to the input shaft 41.

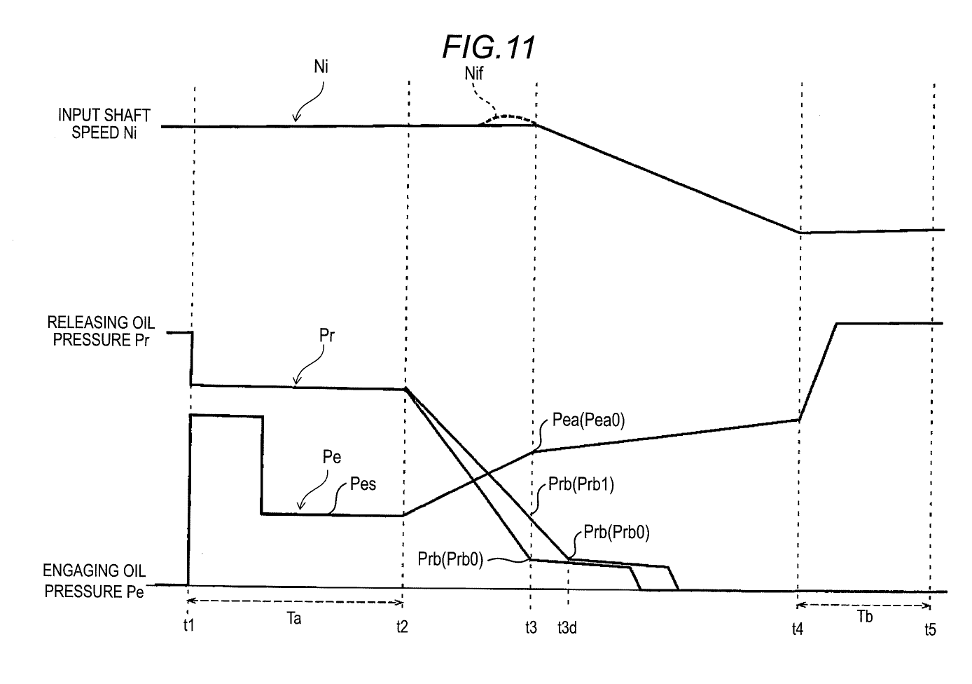

Next, as a third embodiment of the engaging clutch control and the releasing clutch control, another example of correction of increasing at least one of the base value Pea0 of the target engaging oil pressure Pea and the base value Prb0 of the target releasing oil pressure Prb will be described using FIG. 11. In the second embodiment illustrated in FIG. 10, the correction of increasing the target releasing oil pressure Prb to the correction value Prb1 from the base value Prb0 is performed by the oil pressure computing unit 21. Meanwhile, in the third embodiment, as illustrated in FIG. 11, the oil pressure computing unit 21 does not directly change the base value Prb0 itself of the target releasing oil pressure Prb, and delays the time (t3d) at which the releasing oil pressure Pr reaches the base value Prb0 of the target releasing oil pressure Prb to be later than a time (t3) at which the engaging oil pressure Pe reaches the base value Pea0 of the target engaging oil pressure Pea.

Accordingly, as a result of delaying the decrease of the releasing oil pressure Pr, as illustrated in FIG. 11, at a time (t3) at which the engaging oil pressure Pe reaches the base value Pea0 of the target engaging oil pressure Pea, the releasing oil pressure Pr increases to the correction value Prb1 of the target releasing oil pressure Prb similar to an example of FIG. 10. In this manner, in the third embodiment illustrated in FIG. 11, similar to the first embodiment and the second embodiment which are illustrated in the above-described FIGS. 9 and 10, it is also possible to suppress the increase in speed Ni (broken line portion Nif in Ni of FIG. 11) of the input shaft 41 during the upshifting. Accordingly, it is apparent that it is possible to suppress blow-up of the engine speed Ne in the engine 42 linked to the input shaft 41.

As described above, even though not only the correction of increasing at least one of the target engaging oil pressure Pea and the target releasing oil pressure Prb, but also the division of the correction of increasing both of the target engaging oil pressure Pea and the target releasing oil pressure Prb is performed, it is also possible to suppress the increase in speed Ni (broken line portion Nif in Ni of FIGS. 9 to 11) of the input shaft 41 during the upshifting. Accordingly, it is apparent that it is possible to suppress blow-up of the engine speed Ne in the engine 42 linked to the input shaft 41.

In addition, the 2-3 transmission control is described, but the embodiments are not limited thereto, and it is needless to say that similar employment is also possible to employ the upshift control by another grip changing.

Regarding the second torque which is a torque in the same direction in addition to the first torque which is an input torque from the engine output shaft, except for the vehicle which travels as the above-described front tractor pulls the trailer, even in a vehicle which travels as the rear tractor pushes out the front trailer via the connector, the second torque is applied to the automatic transmission to pull the tractor forward as the pushed-out trailer fills the clearance of the connector in accordance with the deceleration in a case of deceleration returning to an accelerator pedal during the upshifting. Therefore, it is apparent that the disclosure can be employed even in a vehicle which travels as the rear tractor pushes out the front trailer via the connector in this manner.

As described above, there is provided the automatic transmission for a vehicle of the embodiments disclosed here including: the automatic transmission mechanism 11 that includes the plurality of friction engaging elements 12a and 12b which change a power transmission path between the input shaft 41 to which power is input from the engine output shaft 43 of a vehicle and the output shaft 45 linked to a driving wheel of the vehicle, the engaging oil pressure control unit 13a which controls the engaging oil pressure Pe that engages the first friction engaging element 12a among the plurality of friction engaging elements, and the releasing oil pressure control unit 13b which controls the releasing oil pressure Pr that releases the second friction engaging element 12b, so as to achieve upshifting to a predetermined gear shift stage; and the control device 20 that includes the engaging oil pressure computing unit 21a which calculates the engaging oil pressure Pe based on the first torque Qi which is an input torque input to the input shaft 41, and outputs the engaging oil pressure Pe to the engaging oil pressure control unit 13a, the releasing oil pressure computing unit 21b which calculates the releasing oil pressure based on the holding torque Qa of the first friction engaging element 12a calculated from the engaging oil pressure and the first torque Qi, and outputs the releasing oil pressure to the releasing oil pressure control unit 13b, the pulled state determination unit 22 which determines whether or not the vehicle is in a pulled state, and the travel load increase calculation unit 23 which calculates the travel load of the vehicle, in which the control device 20 increases at least one of the engaging oil pressure Pea and the releasing oil pressure Prb immediately before the rotation variance of the input shaft 41 is generated based on the increase in travel load calculated by the travel load increase calculation unit 23 in a case where it is determined that the vehicle is in a pulled state by the pulled state determination unit 22. Accordingly, during the upshifting, in a case where a state where the second torque Qs which is the torque in the same direction is applied to the automatic transmission mechanism 11 in addition to the first torque Qi which is the input torque from the engine output shaft 43 is generated, a situation in which the engaging oil pressure Pea or the releasing oil pressure Prb is insufficient can also be suppressed.

As described above, according to the automatic transmission for a vehicle of the embodiments disclosed here, the travel load increase calculation unit 23 includes the vehicle mass calculation unit 23a which calculates a mass of the vehicle. Accordingly, the correction of increasing the oil pressure is appropriately performed based on the increase in travel load.

As described above, according to the automatic transmission for a vehicle of the embodiments disclosed here, the travel load increase calculation unit 23 includes a road surface gradient calculation unit 23b which calculates a road surface gradient that is a gradient of a road surface on which the vehicle travels. Accordingly, the calculation of the increase in travel load becomes more accurate.

As described above, according to the automatic transmission for a vehicle of the embodiments disclosed here, the control device 20 stops increasing at least one of the engaging oil pressure Pea and the releasing oil pressure Prb immediately before the rotation variance of the input shaft 41 is generated based on the increase in travel load calculated by the travel load increase calculation unit 23 in a case of a rise in which the road surface gradient is greater than a predetermined value. Accordingly, the control device 20 can omit the correction of unnecessary increase in oil pressure.

In addition, in a case where a plurality of embodiments exist, it is apparent that it is possible to appropriately combine characteristic parts of each of the embodiments except for a case which is particularly described.

As described above, the control device 20 can suppress a situation in which the engaging oil pressure or the releasing oil pressure is insufficient in consideration of the road surface gradient, by performing the oil pressure control using the correction value, based on the calculation performed by the engaging oil pressure computing unit and the releasing oil pressure computing unit.

An automatic transmission for a vehicle according to an aspect of this disclosure includes: an automatic transmission mechanism that includes a plurality of friction engaging elements which change a power transmission path between an input shaft to which power is input from an engine output shaft of a vehicle and an output shaft linked to a driving wheel of the vehicle, an engaging oil pressure control unit which controls an engaging oil pressure that engages a first friction engaging element among the plurality of friction engaging elements, and a releasing oil pressure control unit which controls a releasing oil pressure that releases a second friction engaging element, so as to achieve upshifting to a predetermined gear shift stage; and a control device that includes an engaging oil pressure computing unit which calculates the engaging oil pressure based on a first torque which is an input torque input to the input shaft, and outputs the engaging oil pressure to the engaging oil pressure control unit, a releasing oil pressure computing unit which calculates the releasing oil pressure based on a holding torque of the first friction engaging element calculated from the engaging oil pressure and the first torque, and outputs the releasing oil pressure to the releasing oil pressure control unit, a pulled state determination unit which determines whether or not the vehicle is in a pulled state, and a travel load increase calculation unit which calculates an increase in travel load of the vehicle, in which the control device increases at least one of the engaging oil pressure and the releasing oil pressure immediately before rotation variance of the input shaft is generated based on an increase in travel load of the vehicle calculated by the travel load increase calculation unit in a case where it is determined that the vehicle is in a pulled state by the pulled state determination unit.

In the automatic transmission for a vehicle according to the aspect of the disclosure, the engaging oil pressure computing unit may calculate a base value of a target engaging oil pressure output to the engaging oil pressure control unit based on the first torque which is an input torque input to the input shaft, as a target oil pressure immediately before the rotation variance of the input shaft is generated.

In the automatic transmission for a vehicle according to the aspect of the disclosure, the releasing oil pressure computing unit may calculate a base value of a target releasing oil pressure output to the releasing oil pressure control unit based on the holding torque and the first torque calculated from the base value of the target engaging oil pressure as a target oil pressure immediately before the rotation variance of the input shaft is generated.

In the automatic transmission for a vehicle according to the aspect of the disclosure, the control device may perform correction in which at least one of the base value of the target engaging oil pressure output to the engaging oil pressure control unit and the base value of the target releasing oil pressure output to the releasing oil pressure control unit is increased to a correction value based on the increase in travel load.

In the automatic transmission for a vehicle according to the aspect of the disclosure, the engaging oil pressure computing unit may calculate a base value of a target engaging oil pressure output to the engaging oil pressure control unit based on the first torque which is an input torque input to the input shaft, as a target oil pressure immediately before the rotation variance of the input shaft is generated.

According to the automatic transmission for a vehicle according to the aspect of the disclosure, the control device increases at least one of the engaging oil pressure and the releasing oil pressure immediately before rotation variance of the input shaft is generated based on an increase in travel load of the vehicle calculated by the travel load increase calculation unit in a case where it is determined that the vehicle is in a pulled state by the pulled state determination unit. Accordingly, during the upshifting, in a case where a state where the second torque which is a torque in the same direction is applied to the automatic transmission mechanism in addition to the first torque which is the input torque from the engine output shaft is generated, a situation in which the engaging oil pressure or the releasing oil pressure is insufficient can be suppressed.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. An automatic transmission for a vehicle comprising:
an automatic transmission mechanism that includes a plurality of friction engaging elements which change a power transmission path between an input shaft to which power is input from an engine output shaft of a vehicle and an output shaft linked to a driving wheel of the vehicle, an engaging oil pressure control unit which controls an engaging oil pressure that engages a first friction engaging element among the plurality of friction engaging elements, and a releasing oil pressure control unit which controls a releasing oil pressure that releases a second friction engaging element, so as to achieve upshifting to a predetermined gear shift stage; and
a control device that includes an engaging oil pressure computing unit which calculates the engaging oil pressure based on a first torque which is an input torque input to the input shaft, and outputs the engaging oil pressure to the engaging oil pressure control unit, a releasing oil pressure computing unit which calculates the releasing oil pressure based on a holding torque of the first friction engaging element calculated from the engaging oil pressure and the first torque, and outputs the releasing oil pressure to the releasing oil pressure control unit, a pulled state determination unit which determines whether or not the vehicle is in a pulled state, and a travel load increase calculation unit which calculates an increase in travel load of the vehicle,
wherein the control device increases at least one of the engaging oil pressure and the releasing oil pressure immediately before rotation variance of the input shaft is generated based on an increase in travel load of the vehicle calculated by the travel load increase calculation unit in a case where it is determined that the vehicle is in a pulled state by the pulled state determination unit.

2. The automatic transmission for a vehicle according to claim 1,
wherein the travel load increase calculation unit includes a vehicle mass calculation unit which calculates a mass of the vehicle.

3. The automatic transmission for a vehicle according to claim 1,
wherein the travel load increase calculation unit includes a road surface gradient calculation unit which calculates a road surface gradient that is a gradient of a road surface on which the vehicle travels.

4. The automatic transmission for a vehicle according to claim 3,
wherein the control device stops increasing at least one of the engaging oil pressure and the releasing oil pressure immediately before rotation variance of the input shaft is generated based on an increase in the travel load calculated by the travel load increase calculation unit in a case of a rise in which the road surface gradient is greater than a predetermined value.

5. The automatic transmission for a vehicle according to claim 1,
wherein the engaging oil pressure computing unit calculates a base value of a target engaging oil pressure output to the engaging oil pressure control unit based on the first torque which is an input torque input to the input shaft, as a target oil pressure immediately before the rotation variance of the input shaft is generated.

6. The automatic transmission for a vehicle according to claim 1,
wherein the releasing oil pressure computing unit calculates a base value of a target releasing oil pressure output to the releasing oil pressure control unit based on the holding torque and the first torque calculated from the base value of the target engaging oil pressure as a target oil pressure immediately before the rotation variance of the input shaft is generated.

7. The automatic transmission for a vehicle according to claim 1,
wherein the control device performs correction in which at least one of the base value of the target engaging oil pressure output to the engaging oil pressure control unit and the base value of the target releasing oil pressure output to the releasing oil pressure control unit is increased to a correction value based on the increase in travel load.

8. The automatic transmission for a vehicle according to claim 1,
wherein the engaging oil pressure computing unit calculates a base value of a target engaging oil pressure output to the engaging oil pressure control unit based on the first torque which is an input torque input to the input shaft, as a target oil pressure immediately before the rotation variance of the input shaft is generated.
